(19) United States
(12) Patent Application Publication
(10) Pub. No.: US 2025/0012735 A1
(43) Pub. Date: Jan. 9, 2025

(54) VISUAL INSPECTION ASSISTANCE DEVICE

(71) Applicant: CKD CORPORATION, Aichi (JP)

(72) Inventor: Takamasa Ohtani, Aichi (JP)

(73) Assignee: CKD CORPORATION, Aichi (JP)

(21) Appl. No.: 18/888,881

(22) Filed: Sep. 18, 2024

Related U.S. Application Data
(63) Continuation of application No. PCT/JP2022/043352, filed on Nov. 24, 2022.

(30) Foreign Application Priority Data
May 17, 2022 (JP) 2022-080921

(51) Int. Cl. G01N 21/95; G01N 21/85; G01N 21/88; G06T 7/00; G06V 10/82

(52) U.S. Cl. CPC G01N 21/9508; G01N 21/85; G01N 21/8803; G06T 7/001; G06V 10/82; G06T 2207/20081

(57) ABSTRACT

A visual inspection assistance device includes: a conveying device that conveys tablets as an object of a visual inspection; an imaging device that takes an image of the tablets that are conveyed by the conveying device; a display device; a central processing unit (CPU) that: determines, based on image data obtained by the imaging device, whether one or more of the tablets are defective, and displays, in the display device, information identifying the one or more of the tablets that have been determined to be defective; and a conveying control device that temporarily stops the conveying device from conveying the tablets in response to the CPU determining that the one or more of the tablets are detective.

### BACKGROUND

### Technical Field

The present disclosure relates to a visual inspection assistance device used for a visual inspection of tablets.

### Description of Related Art

Visual inspection of an inspection object that is conveyed has been performed widely. A proposed device used for visual inspection of tablets as an inspection object includes a reversing portion configured to reverse front faces and rear faces of tablets in the middle of a conveying path of the tablets (as described in, for example, Patent Literature 1). This device enables a visual inspection for one of the front faces and the rear faces of the tablets to be performed in upstream of the reversing portion and a visual inspection for another of the front faces and the rear faces of the tablets to be performed in downstream of the reversing portion. This device thus enables only one examiner to perform an inspection for the front faces and the rear faces of the tablets.

### PATENT LITERATURE

Patent Literature 1: Japanese Patent No. 2001-95898A

The device described above causes inspection of the tablets to be performed only by the visual inspection. The examiner is thus likely to overlook a tablet that is defective (defective tablet). The examiner who finds the defective tablet is supposed to remove the defective tablet from a conveying path of the tablets. The examiner is, however, likely to miss out the defective tablet or to mistakenly remove a non-defective tablet that is different from the defective tablet. The occurrence of such oversight, missing-out or confusion causes the defective tablet to flow to the downstream.

### SUMMARY

By taking into account the circumstances described above, one or more embodiments of the present disclosure provide a visual inspection assistance device that more certainly prevents the occurrence of the oversight, the missing-out or the confusion described above and thereby further enhances the reliability of the visual inspection.

The following describes each of various aspects of the present disclosure. Functions and advantageous effects that are characteristic of each of the aspects are also described as appropriate.

Aspect 1. There is provided a visual inspection assistance device provided with a conveying device that conveys tablets as an object of a visual inspection. The visual inspection assistance device comprises an imaging device that takes an image of the tablets that are conveyed by the conveying device; a display device; a central processing unit (CPU) that: determines, based on image data obtained by the imaging device, whether one or more of the tablets are defective, and display, in the display device, information identifying the one or more of the tablets that have been determined to be defective; and a conveying control device that temporarily stops the conveying device from conveying the tablets in response to the CPU determining that the one or more of the tablets are detective.

In the visual inspection assistance device of above Aspect 1, the CPU determines whether one or more of the tablets are defective, the tablets being conveyed by the conveying device (i.e., that are the object of the visual inspection). In the case of determination as defective, the conveying of the tablets is temporarily stopped. Additionally, the information identifying the one or more tablets that have been determined to be defective is displayed in the display device.

This configuration accordingly enables the examiner who performs a visual inspection to readily identify a tablet that is defective (defective tablet) among a plurality of tablets by effectively using the contents of display in the display device. The tablets are temporarily stopped in the case of determination as defective, so that the examiner can more precisely remove the identified defective tablet. This configuration thus more certainly prevents the examiner from overlooking the defective tablet, from missing out the defective tablet, and from mistakenly removing a non-defective tablet that is different from the defective tablet. As a result, this more certainly prevents the defective tablet from flowing to the downstream and further enhances the reliability of the visual inspection.

Aspect 2. In the visual inspection assistance device described in above Aspect 1, the CPU may be configured to display the information identifying the one or more of the tablets that have been determined to be defective, in association with the image data with regard to the tablet, in the display device.

In the visual inspection assistance device of above Aspect 2, the information identifying the one or more of the tablets that have been determined to be defective is displayed, in association with the image data with regard to the tablet, in the display device (for example, a specific mark indicating a defective is displayed to be overlapped with a defective tablet in the image data). This configuration accordingly enables the defective tablet to be identified more easily and further reduces the labor and the time required for removal of the defective tablet.

Aspect 3. In the visual inspection assistance device described in above Aspect 1, the CPU may control the imaging device to image a range corresponding to the tablets that have been determined to be defective and to obtain redetermination image data during a temporary stop of the tablets. The CPU may determine whether one or more of the tablets are defective based on the redetermination image data. The conveying control device may be configured to restart the conveying device to resume the conveying of the tablets that has been temporarily stopped, under condition that the tablets are non-defective as a result of the determining based on the redetermination image data.

In the case where a defective tablet is found and the conveying of the tablets is temporarily stopped, the configuration of above Aspect 3 allows the conveying device to be restarted and resume the conveying of the tablets, only when the result of determination as “non-defective” is given based on the redetermination image data obtained by imaging of a range corresponding to at least the tablets that have been determined to be defective (i.e., a range including a position where the defective tablet is located). This configuration furthermore certainly prevents the defective tablet from mistakenly flowing to the downstream, even when the examiner forgets to remove the defective tablet or mistakenly removes another tablet. As a result, this furthermore enhances the reliability of the visual inspection.

Aspect 4. In the visual inspection assistance device described in any of above Aspects 1 to 3, the tablet may have a front face and a rear face. The conveying device may comprises a tablet support base configured to support the tablets that are conveyed, wherein at least part of the tablet support base has a transmission part that is transparent or translucent. The imaging device may comprise a first imaging device and a second imaging device placed at such positions that the tablet support base is placed between the first imaging device and the second imaging device. The first imaging device may be configured to take images of one of the front faces and the rear faces of the tablets, and the second imaging device may be configured to take mages of another of the front faces and the rear faces of the tablets through the transmission part. The CPU may determine whether one or more of the tablets are defective based on image data with regard to the front faces and the rear faces of the tablets obtained by the first imaging device and the second imaging device.

The configuration of above Aspect 4 takes advantage of the transmission part to determine whether one or more of the tablets are defective with respect to the front faces and the rear faces of the tablets. This enables determining whether one or more of the tablets are defective with the higher accuracy. The second imaging device is placed below the tablet support bae. This configuration prevents the second imaging device from interfering with the visual inspection.

Furthermore, in the case of application of the configuration of above Aspect 4 to the configuration of above Aspect 3, the conveying device is allowed to be activated, only when both the front faces and the rear faces of the tablets are determined as non-defective by the determining based on the redetermination image data. This configuration accordingly does not allow the conveying device to be activated in the case where the examiner misses out a defective tablet and this defective tablet is turned upside down. Accordingly, this configuration significantly effectively prevents the defective tablet from flowing to the downstream.

Aspect 5. In the visual inspection assistance device described in above Aspect 1, the conveying device may be configured to convey the tablets arrayed in a plurality of lines. The CPU may obtain reconfiguration image data that is reconfigured by inputting original image data that is based on the image data obtained by the imaging device into a model, wherein the model is generated by learning of a neural network using only learning data based on image data with regard to non-defective tablets, and the neural network comprises an encoder portion configured to extract a feature quantity from input image data, and a decoder portion configured to reconfigure image data from the feature quantity, compare the original image data with the reconfiguration image data, and determine whether one or more of the tablets are defective based on a result of comparison by the comparing. The learning data may comprise image data obtained by extracting, per each line of the tablets, an area corresponding to one line of multiple tablets from the image data with regard to the non-defective tablets, and the original image data may comprise image data obtained by extracting, per each line of the tablets, an area corresponding to one line of multiple tablets from the image data obtained by the imaging device.

The “image data with regard to the non-defective tablets” may be, for example, image data with regard to non-defective tablets accumulated by previous quality judgments (i.e., determination about whether one or more of the tablets are defective) or virtual non-defective image data generated by using this image data or the like.

The “neural network” described above includes, for example, a convolution neural network having a plurality of convolution layers. The “learning” described above includes, for example, deep learning. The “identification unit (generation model)” described above includes, for example, an autoencoder and a convolution autoencoder.

Additionally, the “identification unit” is generated by learning using only the image data with regard to the non-defective tablets. Accordingly, reconfiguration image data generated by inputting original image data with regard to a defective tablet into the identification unit is substantially consistent with original image data with omission of a noise part (a defective part). In the case where a tablet has a defective part, virtual image data with regard to the tablet on the assumption of the absence of any defective part is accordingly generated as the reconfiguration image data.

One possible method may utilize, for example, image data (entire area data) corresponding to an entire field of vision of the imaging device or image data (individual tablet data) obtained by extracting an area of each individual tablet from the entire area data, as the learning data used for learning of the identification unit or as the original image data used for the comparing (i.e., the quality judgment or the determination about whether one or more of the tablets are defective). The method of utilizing the entire area data is, however, likely to require an extremely large amount of data for learning and is thus likely to increase the cost required for the learning. The respective tablets slightly have different shapes and different sizes, so that the method of utilizing the individual tablet data is likely to require extremely troublesome settings for extraction of the individual tablet data or is likely to require a significantly long time period for the extraction process and to make the extraction process difficult as a result.

The configuration of above Aspect 5, on the other hand, uses the image data obtained by extracting the area corresponding to one line of multiple tablets (that are adjacent to one another in a conveying direction) per each line of the tablets is used as the learning data and as the original image data. This configuration relatively reduces the amount of data required for learning and is thereby expected to reduce the cost required for learning. This configuration also further facilitates the process of extracting the learning data and the original image data.

Furthermore, the configuration of above Aspect 5 compares the original image data with the reconfiguration image data, which is reconfigured by inputting the original image data into the identification unit, and determines whether one or more of the tablets are defective based on the result of the comparison. Both the image data to be compared with each other respectively relate to one identical tablet. Accordingly, the respective image data to be compared with each other have substantially the same shapes and the appearances of the tablet. This configuration does not need to set relatively mild judgment conditions with a view to preventing false detection due to a difference in the shape or in the appearance but allows the stricter judgment conditions to be set. Moreover, this configuration enables the imaging conditions (for example, the locations and the angles of placement of the tablets, the light and dark conditions, and the angles of view of the cameras) to be consistent with each other in both the image data that are to be compared with each other. As a result, this enables determining whether one or more of the tablets are defective with extremely high accuracy.

Aspect 6. In the visual inspection assistance device described in above Aspect 1, the tablet may have a front face, a rear face, and a side face located between the front face and the rear face. The conveying device may include a reversing portion configured to reverse a front side and a rear side of the tablets that are conveyed. The imaging device may comprise a side face imaging device that takes images of the side faces of the tablets located in the reversing portion, and the CPU may determine whether one or more of the tablets are defective with regard to the side faces of the tablets, based on image data obtained by the side face imaging device.

The configuration of above Aspect 6 is provided with the reversing portion configured to reverse the front side and the rear side of the tablets. This configuration enables the visual inspection of the front faces and the rear faces of the tablets to be performed easily.

Furthermore, the configuration of above Aspect 6 enables the quality judgment with regard to the side faces of the tablets to be executed by utilizing the reversion portion. This configuration further enhances the accuracy in the quality judgment of the tablets. This configuration also furthermore certainly prevents the defective tablet from flowing to the downstream and thereby further enhances the reliability of the visual inspection.

The technical features described above in the respective aspects may be combined appropriately. For example, the technical features with regard to above Aspect 2 may be combined with the technical features with regard to above Aspect 3.

### BRIEF DESCRIPTION OF DRAWINGS

FIG. 1 is a schematic diagram illustrating the schematic configuration of a visual inspection assistance apparatus and periphery thereof,

FIG. 2 is a schematic perspective view illustrating a conveying device and periphery thereof,

FIG. 3 is a side view illustrating a tablet;

FIG. 4 is a block diagram showing the functional configuration of a determination unit;

FIG. 5 is a schematic plan view illustrating tablets conveyed and an inspection target area;

FIG. 6 is a schematic diagram illustrating image data obtained by cameras;

FIG. 7 is a schematic diagram illustrating original image data;

FIG. 8 is a schematic diagram illustrating learning data;

FIG. 9 is a schematic diagram illustrating the structure of a neural network;

FIG. 10 is a flowchart showing the flow of a learning process of the neural network;

FIG. 11 is a flowchart showing the flow of a process when quality judgment of tablets is executed;

FIG. 12 is a flowchart showing the flow of a quality judgment process;

FIG. 13 is a schematic diagram illustrating one example of information displayed on display portions in the case of determination of a tablet as defective;

FIG. 14 is a schematic diagram illustrating the schematic configuration of a visual inspection assistance apparatus provided with a transmission part and periphery thereof according to one or more embodiments;

FIG. 15 is a schematic perspective view illustrating a conveying device provided with a transmission part and periphery thereof according to one or more embodiments;

FIG. 16 is a schematic perspective view illustrating a side face camera used to take images of side faces of tablets and periphery thereof according to one or more embodiments;

FIG. 17 is a schematic diagram illustrating one example of information displayed on the display portions according to one or more embodiments;

FIG. 18 is a schematic diagram illustrating one example of information displayed on the display portions according to one or more embodiments; and

FIG. 19 is a schematic diagram illustrating one example of information displayed on the display portions according to one or more embodiments.

### DETAILED DESCRIPTION OF EMBODIMENTS

The following describes embodiments with reference to drawings. A visual inspection assistance apparatus is an apparatus used for a visual inspection of tablets 9 (shown in FIG. 3) that is conveyed. The tablet 9 is a flat pill including a front face 9a, a rear face 9b and a side face 9c located between these faces 9a and 9b (as shown in FIG. 3).

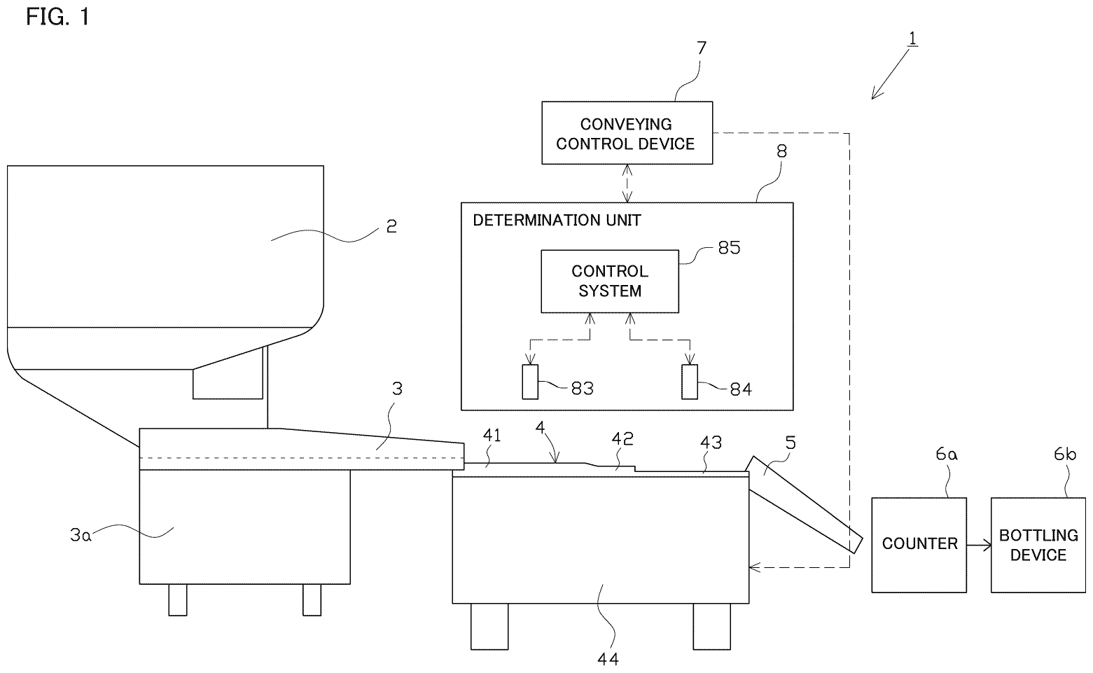

As shown in FIG. 1, a visual inspection assistance apparatus 1 includes a tablet supply device 2, a supply tram 3, a conveying device 4 and a chute 5. According to one or more embodiments, the conveying device 4 configures the “conveying unit”. A counter 6a and a bottling device 6b are provided in a downstream of the chute 5. The counter 6a is configured to count the tablets 9, which underwent a visual inspection, and the bottling device 6b is configured to fill a container with the tablets 9.

The tablet supply device 2 is, for example, a hopper and is configured to supply the tablets 9 intermittently to the supply tram 3.

The supply tram 3 is configured to array the tablets 9 in lines and convey the arrayed tablets 9 toward the conveying device 4. The supply tram 3 is provided with a predetermined first vibrator 3a. The tablets 9 on the supply tram 3 are conveyed to the conveying device 4 by the operation of the first vibrator 3a.

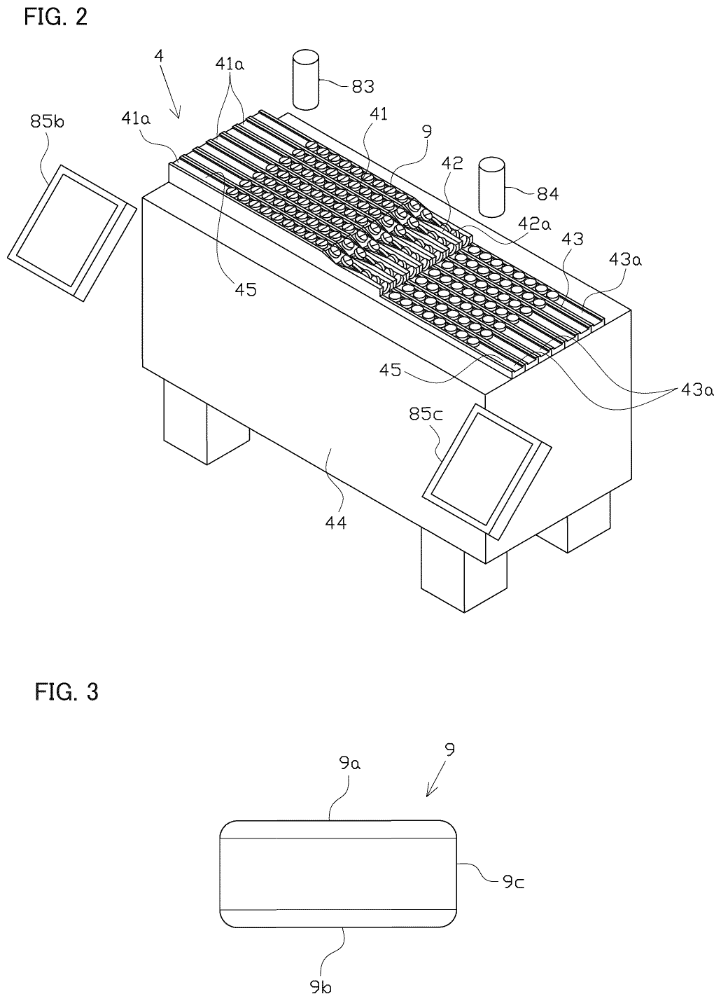

The conveying device 4 is configured to convey the tablets 9 arrayed in multiple lines as the object of visual inspection. As shown in FIG. 2, the conveying device 4 includes an upstream side conveying portion 41, a reversing portion 42, a downstream-side conveying portion 43 and a second vibrator 44. With regard to examiners who perform the visual inspection, for example, one examiner is placed on the side of the upstream-side conveying portion 41 and another examiner is placed on the side of the downstream-side conveying portion 43. In some cases, the examiners may be placed on respective sides of the upstream-side conveying portion 41 and on respective sides of the downstream-side conveying portion 43, such that the conveying portion 41 is located between the two examiners and the conveying portion 43 is located between the two other examiners. In this case, a total of four or more examiners may be placed. FIG. 2 and the other relevant drawings illustrate only part of a large number of the tablets 9 that are conveyed.

The upstream-side conveying portion 41 is configured to continuously convey the tablets 9 to a downstream side in such a state that one of the front faces 9a and the rear faces 9b thereof face up. The upstream-side conveying portion 41 is provided with a plurality of upstream-side conveying grooves 41a that are formed in parallel to each other to convey the tablets 9 arrayed in lines to the downstream side. In the course of conveyance by the upstream-side conveying portion 41, one faces of the tablets 9, i.e., either the front faces 9a or the rear faces 9b of the respective tablets 9, are the target of a visual inspection.

The reversing portion 42 is configured to reverse the front side and the rear side of the tablets 9, while continuously conveying the tablets 9. The reversing portion 42 is provided with a plurality of middle-side conveying grooves 42a, which are continuous with the upstream-side conveying grooves 41a and which are in a shape gradually twisted toward the downstream side. This configuration causes the tablets 9 conveyed in such a state that one of the front faces 9a and the rear faces 9b face up in the upstream-side conveying portion 41, to pass through the middle-side conveying grooves 42a and to be conveyed to the downstream-side conveying portion 43 in such a state that another of the front faces 9a and the rear faces 9b face up.

The downstream-side conveying portion 43 is configured to continuously convey the tablets 9 to the downstream side in such a state that the front faces 9a or the rear faces 9b that face down in the upstream-side conveying portion 41 as lower faces are turned to face up as upper faces. The downstream-side conveying portion 43 is provided with a plurality of downstream-side conveying grooves 43a, which are continuous with the middle-side conveying grooves 42a and which are configured to convey the tablets 9 in the arrayed state toward the chute 5. In the course of conveyance by the downstream-side conveying portion 43, opposite faces of the tablets 9, which are opposite to the front faces 9a or the rear faces 9b of the tablets 9 undergoing the visual inspection in the upstream-side conveying portion 41, are the subsequent target of the visual inspection. The tablets 9 passing through the downstream-side conveying portion 43 flow down along the chute 5 and are conveyed to the counter 6a.

According to one or more embodiments, a tablet support base 45, which is provided to configure bottom portions of the respective conveying grooves 41a, 42a and 43a and to support the lower faces of the tablets 9 upward, is configured to have an upper face of an inclined plane that is gradually lowered toward the downstream.

The second vibrator 44 is a device configured to apply vibration to the upstream-side conveying portion 41, the reversing portion 42, and the downstream-side conveying portion 43. Applying vibration from the second vibrator 44 to the upstream-side conveying portion 41 and the other portions causes the tablets 9 located in the respective grooves 41a, 42a and 43a to be conveyed to the downstream side. When the operation of the second vibrator 44 is stopped, on the other hand, the conveying of the tablets 9 is stopped.

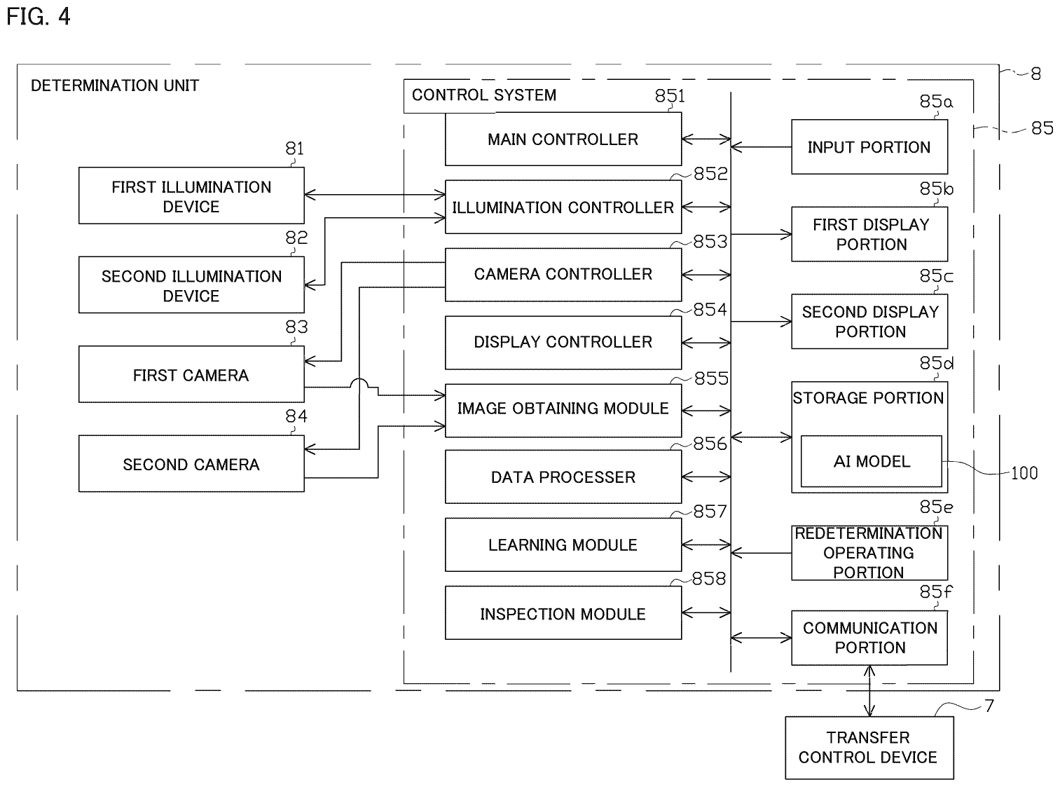

The visual inspection assistance device 1 is also provided with a conveying control device 7 and a determination unit 8, in addition to the conveying device 4 and the other components described above, as shown in FIG. 1 and FIG. 4. According to one or more embodiments, the conveying control device 7 configures the “conveying control unit”.

The conveying control device 7 is described first. The conveying control device 7 may comprises a central processing unit (CPU) and serves to control the operation of the conveying device 4 (more specifically, the operation of the second vibrator 44) and thereby start (resume) or temporarily stop the conveying of the tablets 9 in the conveying device 4.

The conveying control device 7 is configured to make communication with a control system 85 of the determination unit 8 described later and to obtain results of quality judgment of the tablets 9 executed by the control system 85 (more specifically, by an inspection module 858 thereof described later). In the case where the control system 85 determines a tablet 9 as defective, the conveying control device 7 temporarily stops the conveying of the tablets 9 by the conveying device 4. More specifically, according to one or more embodiments, imaging of one tablet 9 is performed at least twice by each of cameras 83 and 84 described later. When this one tablet 9 is determined as defective, based on image data obtained by first imaging of the tablets 9 by the cameras 83 and 84, the conveying control device 7 controls the conveying device 4 to temporarily stop a further conveying of the tablets 9 at a timing when second imaging of this one tablet 9 is performed.

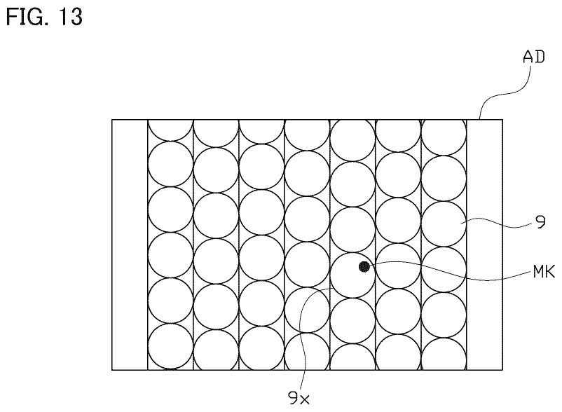

A predetermined conveyance operation device (not shown) is connected with the conveying control device 7. For example, the examiner who performs visual inspection may operate the conveyance operation device to basically switch over between a start (restart) and a temporary stop of the conveying device 4 and thereby to start (resume) or temporarily stop the conveying of the tablets 9. In the state that the conveying of the tablets 9 is temporarily stopped, in response to the determination of one tablet 9 as defective, as described above, however, the conveying control device 7 is configured to permit a restart of the conveying device 4 by the operation of the conveyance operation device, only upon the satisfaction of a condition that the result of redetermination of this one tablet 9, which is determined as defective (hereinafter simply referred to as “defective tablet 9x” (shown in FIG. 13)), is “non-defective”, based on image data obtained by imaging a range corresponding to the defective tablet 9x again (redetermination image data described later). Accordingly, in the case where the conveying of the tablets 9 is temporarily stopped in response to the determination of one tablet 9 as defective, the conveying of the tablets 9 is not allowed to be resumed by simply operating the conveyance operation device.

The following describes the determination unit 8. The determination unit 8 includes a first illumination device 81, a second illumination device 82, a first camera 83, a second camera 84 and a control system 85. According to one or more embodiments, the first camera 83 configures the “first imaging device”, and the second camera 84 configures the “second imaging device”. The first camera 83 and the second camera 84 configure the “imaging device”.

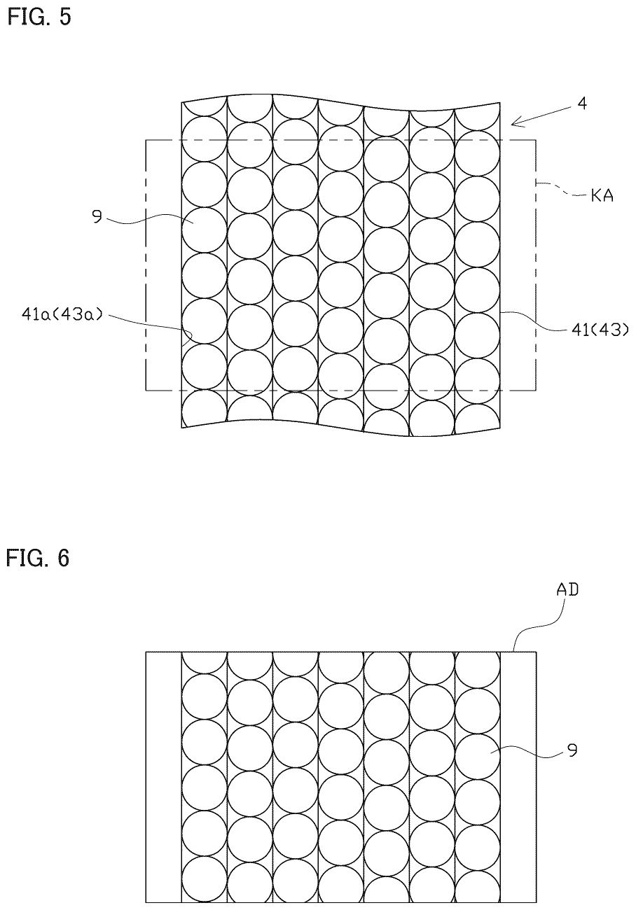

The first illumination device 81 and the second illumination device 82 are configured to irradiate a predetermined inspection target area KA including at least all lines of the arrayed tablets 9 that are conveyed (as shown in FIG. 5) downward with a predetermined light (for example, white light or the like). The first illumination device 81 irradiates the inspection target area KA in the upstream-side conveying portion 41 with light, and the second illumination device 82 irradiates the inspection target area KA in the downstream-side conveying portion 43 with light.

The first camera 83 and the second camera 84 are configured to take images of the inspection target area KA from substantially directly above. Each of the cameras 83 and 84 includes an imaging element, such as a CCD (Charge Coupled Device)-type image sensor or a CMOS (Complementary Metal Oxide Semiconductor)-type image sensor, and an optical system (for example, a lens unit and a diaphragm) configured to form an image of an imaging object onto the imaging element. Each of the cameras 83 and 84 may, however, employ an imaging element other than those described above. Each of the cameras 83 and 84 is placed such that an optical axis of the camera 83 or 84 is orthogonal to an upper face of the tablet support base 45.

Each of the cameras 83 and 84 is driven and controlled by the control system 85 (more specifically, by a camera controller 853 thereof described later). Entire area data AD (shown in FIG. 6), which is image data showing an entire field of view of the camera 83 or 84, is obtained by imaging of the tablets 9 by the camera 83 or 84. According to one or more embodiments, the entire field of view of the camera 83 or 84 corresponds to the inspection target area KA.

Image data taken and generated by each of the cameras 83 and 84 is converted into a digital signal inside of each of the cameras 83 and 84 and is, in the form of the digital signal, conveyed to and stored into the control system 85 (more specifically, conveyed to and stored into an image obtaining module 855 thereof described later). The control system 85 performs a variety of image processing operations, arithmetic operations and the like described later, based on the image data.

The control system 85 is configured by a computer including, for example, a central processing unit (CPU) that performs predetermined arithmetic operations, a ROM (Read Only Memory) that stores a variety of instructions or programs, fixed value data and the like, a RAM (Random Access Memory) that temporarily stores various data in the course of execution of the various arithmetic operations, and peripheral circuits of the foregoing; input and output devices; a display device; and the like.

The CPU operates according to the variety of instructions or programs, so that the control system 85 serves as various function modules including a main controller 851, an illumination controller 852, a camera controller 853, a display controller 854, an image obtaining module 855, a data processor 856, a learning module 857 and an inspection module 858 described later.

The respective function modules described above are, however, implemented by cooperation of the various hardware components, such as the CPU, the ROM and the RAM. There is no need to clearly distinguish the functions implemented by the hardware configuration and the functions implemented by the software configuration from each other. Part or the entirety of these functions may be implemented by a hardware circuit, such as an IC.

The control system 85 is further provided with, for example, an input portion (or input device) 85a that is configured by a keyboard and a mouse, a touch panel or the like; a first display portion (or first display) 85b and a second display portion (or second display) 85c, each of which is configured by a liquid crystal display or the like and provided with a display screen to display various pieces of information; a storage portion (or storage) 85d that is configured to store a variety of data and instructions or programs, the results of arithmetic operations, the results of inspection, and the like; and a communication portion (or communication interface) 85f that is configured to send and receive a variety of data from and to outside. The control system 85 is also provided with a redetermination operating portion (or redetermination operating device) 85e at a position that allows the examiner to operate. According to one or more embodiments, each of the first display portion 85b and the second display portion 85c configures the “display device”.

The following describes the above respective function modules configuring the control system 85 more in detail.

The main controller 851 is a function module configured to control the entire determination unit 8 and to send and receive various signals to and from other function modules, such as the illumination controller 852 and the camera controller 853.

The illumination controller 852 is a function module configured to control the illumination devices 81 and 82, in response to command signals from the main controller 851.

The camera controller 853 is a function module configured to control the cameras 83 and 84 and more specifically to control, for example, imaging timings by the cameras 83 and 84, in response to command signals from the main controller 851. According to one or more embodiments, the camera controller 853 controls the respective cameras 83 and 84 such as to take images of an identical tablet 9 at least twice in the upstream-side conveying portion 41 and to take images of the identical tablet 9 at least twice in the downstream-side conveying portion 43.

In response to a predetermined operation of the redetermination operating portion 85e, the camera controller 853 controls the respective cameras 83 and 84 such as to take images of a range corresponding to the defective tablet 9x (more specifically, a range including a location where the defective tablet 9x is located) during a temporary stop of the tablets 9. In other words, the camera controller 853 controls the cameras 83 and 84 such as to obtain redetermination image data that is image data for redetermination. According to one or more embodiments, the camera controller 853 configures the “imaging control unit”.

The display controller 854 is configured to control the contents of display in the respective display portions 85b and 85c, based on the information stored in the storage portion 85d. According to one or more embodiments, the display controller 854 configures the “display control unit”.

The image obtaining module 855 is a function module configured to capture the image data taken and obtained by the respective cameras 83 and 84.

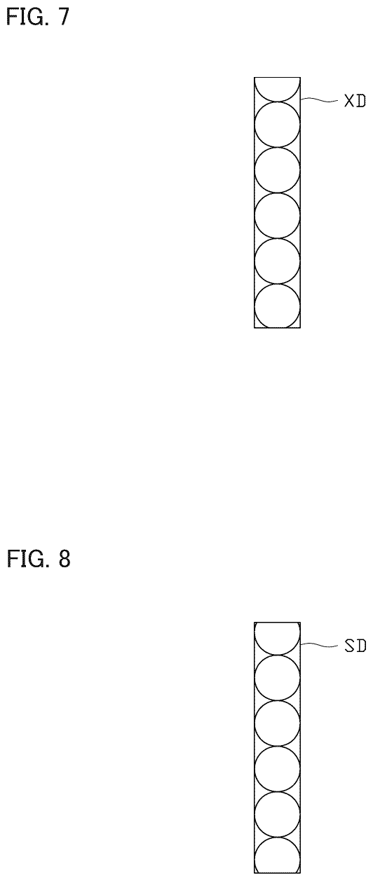

The data processor 856 is a function module configured to perform predetermined image processing such as to process the image data captured by the image obtaining module 855. According to one or more embodiments, the data processor 856 performs a process of extracting an area corresponding to a plurality of tablets 9 arrayed in a line from the entire area data AD (image data showing the entire field of view of the camera 83 or 84), per each line of the tablets 9 and thereby obtain original image data XD and learning data SD (as shown in FIG. 7 and FIG. 8). The original image data XD is used for quality judgment of the tablets 9, and the learning data SD is used for learning of a neural network 90 described later. Multiple sets of the original image data XD and the learning data SD (an identical number of sets with the number of lines of the arrayed tablets 9 according to one or more embodiments) can be obtained from one entire area data AD.

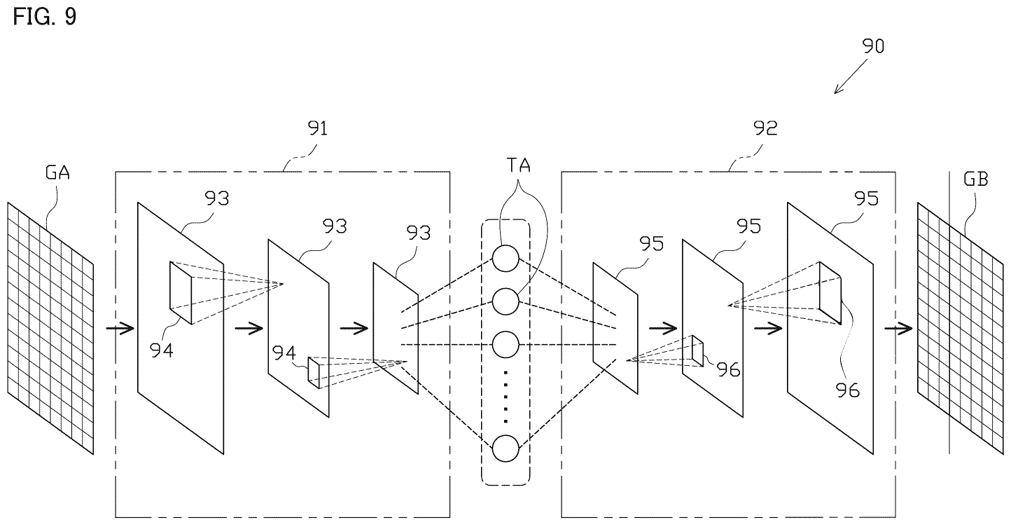

The learning module 857 is a function module configured to perform learning of a deep neural network 90 (hereinafter simply referred to as “neural network 90”: as shown in FIG. 9) by using the learning data SD and to construct an AI (Artificial Intelligence) model 100 serving as the “identification unit”.

The AI model 100 according to one or more embodiments is a generation model constructed by deep learning of the neural network 90 using only image data with regard to the inspection target area KA of non-defective tablets 9, as the learning data SD, and has a so-called autoencoder structure.

The structure of the neural network 90 is described with reference to FIG. 9. FIG. 9 is a schematic diagram conceptually illustrating the structure of the neural network 90. As shown in FIG. 9, the neural network 90 has the configuration of a convolutional autoencoder (CAE) including an encoder portion 91 serving as an “encoding unit” configured to extract a feature quantity (latent variable) TA from input image data GA and a decoder portion 92 serving as a “decoding unit” configured to reconstruct image data GB from the feature quantity TA.

The configuration of the convolutional autoencoder is publicly known, so that the detailed description thereof is omitted. The encoder portion 91 has a plurality of convolution layers 93. Each of the convolution layers 93 is configured to output the results of convolution operations of input data using a plurality of filters (kernels) 94, as input data for a subsequent layer. Similarly, the decoder portion 92 has a plurality of deconvolution layers 95. Each of the deconvolution layers 95 is configured to output the results of deconvolution operations of input data using a plurality of filters (kernels) 96, as input data of a subsequent layer. The learning process described later updates weights (parameters) of the respective filters 94 and 96.

Referring back to FIG. 4, the inspection module 858 is a function module configured to execute quality judgment of the tablets 9 that are conveyed by the conveying device 4. According to one or more embodiments, the inspection module 858 performs, for example, an inspection for determining whether any foreign substance or dirt adheres to any of the tablets 9 and an inspection for determining whether any of the tablets 9 has any damage, such as cracking or breaking. In the case where the tablet 9 has a printed part, the inspection module 858 may execute quality judgment of the printed part. According to one or more embodiments, imaging of one identical tablet 9 is performed at least twice by each of the cameras 83 and 84, as described above. Accordingly, quality judgment is executed at least twice with regard to the front face 9a of one tablet 9 and is performed at least twice with regard to the rear face 9b of the tablet 9. According to one or more embodiments, the inspection module 858 configures the “determination unit”.

Imaging of the front face 9a and imaging of the rear face 9b of one identical tablet 9 are respectively performed at least twice, basically with a view to enhancing the accuracy in the quality judgment of the tablet 9. In the case of a tablet 9 that is defective, first imaging is performed to find this defective tablet 9x, and second imaging is performed to obtain image data in the state that this defective tablet 9x is temporarily stopped. The image data in the state that the defective tablet 9x is temporarily stopped is used for identifying the defective tablet 9x in a determination result responding process performed at step S305 described later. Using such image data enables the conditions of the tablets 9 (for example, the positions, the intervals, and the orientations) shown by the image data to be substantially consistent with the actual conditions of the tablets 9 that are temporarily stopped.

In response to a predetermined operation of the redetermination operating portion 85e, the inspection module 858 executes the quality judgment of the tablets 9 again, based on the redetermination image data described above.

The first display portion 85b and the second display portion 85c are placed at such positions as to be visually recognizable by the examiners who perform the visual inspection, for example, in the vicinity of the conveying device 4 (as shown in FIG. 2). According to one or more embodiments, the first display portion 85b is provided corresponding to the upstream-side conveying portion 41, and the second display portion 85c is provided corresponding to the downstream-side conveying portion 43. The display controller 854 controls the respective display portions 85b and 85c, such as to cause, for example, the results of the quality judgment based on the image data obtained by the first camera 83 to be displayed on the first display portion 85b and to cause, for example, the results of the quality judgment based on the image data obtained by the second camera 84 to be displayed on the second display portion 85c. The positions where the respective display portions 85b and 85c are placed may be changed appropriately, as long as the positions allow the examiners to check the information displayed on the respective display portions 85b and 85c. The respective display portions 85b and 85c may be installed or may be portable. The number of the display portions may be changed appropriately, for example, according to the number of the examiners.

The storage portion 85d is configured by, for example, an HDD (Hard Disk Drive), an SSD (Solid State Drive) or the like and has a predetermined storage area to store, for example, the AI model 100 (the neural network 90 and learning information obtained by learning thereof). The storage portion 85d also has a function of storing the image data obtained by the respective cameras 83 and 84 and the results of the quality judgment of the tablets 9 executed by the inspection module 858.

The redetermination operating portion 85e is an operating device used when the quality judgment of the tablets 9 is executed again by the inspection module 858 in the state that the conveying of the tablets 9 is temporarily stopped. In response to a predetermined operation of the redetermination operating portion 85e, the cameras 83 and 84 obtain the redetermination image data, and the inspection module 858 executes the quality judgment of the tablets 9, based on the redetermination image data, as described above

The communication portion 85f is provided with, for example, a wireless communication interface in conformity with communication standards, such as a wired LAN (Local Area Network) and a wireless LAN and is configured to send and receive various data to and from outside. For example, the results of the inspection performed by the inspection module 858 are output via the communication portion 85f to the outside (for example, the conveying control device 7).

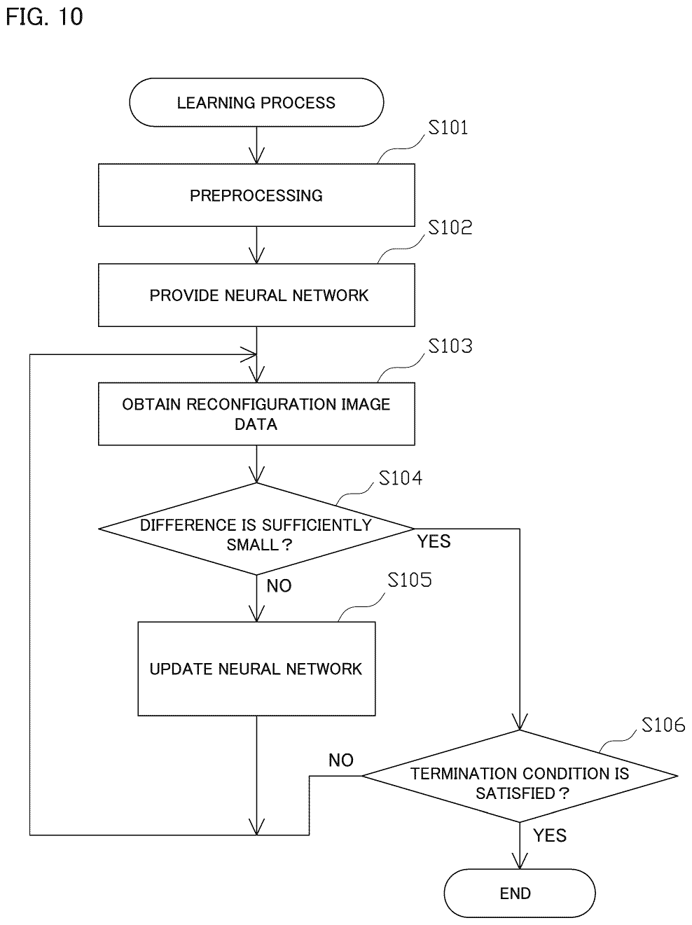

The following describes a learning process of the neural network 90 performed by the determination unit 8, with reference to the flowchart of FIG. 10.

When the learning process is started by execution of a predetermined learning program, the main controller 951 first performs preprocessing for learning of the neural network 90 at step S101.

In this preprocessing, the main controller 951 first obtains a large number of quality judgment information stored in the storage portion 85d. The main controller 951 subsequently obtains image data with regard to the tablets 9 determined as non-defective by the quality judgment, from the storage portion 85d, based on the quality judgment information. This image data is the entire area data AD showing the entire inspection target area KA. The data processor 856 then extracts an area corresponding to one line of multiple tablets 9 from the image data (from the entire area data AD), per each line of the tablets 9, so as to generate the learning data SD. The learning data SD has the same format as that of the original image data XD and is used for learning of the neural network 90 as described above. This preprocessing is repeated until a required number of the learning data SD are obtained.

For example, virtual non-defective image data generated by using the image data with regard to the non-defective tablets 9 may be used as the learning data SD.

When the required number of the learning data SD are obtained at step S101, the learning module 857 provides a non-learnt neural network 90, in response to a command from the main controller 851 at subsequent step S102. For example, the learning module 857 reads out a neural network 90 stored in advance in the storage portion 85d or the like. In another example, the learning module 857 constructs a neural network 90, based on network configuration information (for example, the number of layers of the neural network and the number of nodes in each layer) stored in the storage portion 85d or the like.

At step S103, the learning module 857 obtains reconfiguration image data. More specifically, in response to a command from the main controller 851, the learning module 857 gives the learning data SD obtained at step S101, as input data, into an input layer of the neural network 90 and obtains reconfiguration image data output from an output layer of the neural network 90. The reconfiguration image data has the same format as those of the learning data SD and the original image data XD and is image data showing an area corresponding to one line of the tablets 9.

At subsequent step S104, the learning module 857 compares the input image data (the learning data SD) with the reconfiguration image data output from the neural network 90 and determines whether a difference therebetween is sufficiently small (whether the difference is equal to or less than a predetermined reference value).

When the difference is sufficiently small, the learning module 857 subsequently determines whether a termination condition of learning is satisfied at step S106. It is determined that the termination condition is satisfied, for example, in the case where an affirmative answer is continually given a predetermined number of times at step S104 without proceeding to the processing of step S105 described later or in the case where the learning operation using the entirety of the provided learning data SD is repeated a predetermined number of times. When the termination condition is satisfied, the learning module 857 stores the neural network 90 and the learning information thereof (updated parameters and the like described later), as the AI model 100, into the storage portion 85d and terminates this learning process.

When the termination condition is not satisfied at step S106, on the other hand, the learning process returns to step S103 to perform learning of the neural network 90 again.

When the difference is not sufficiently small at step S104, the learning process performs a network updating process (learning of the neural network 90) at step S105 and then goes back to step S103 to repeat the series of processing described above.

More specifically, the network updating process at step S105 uses a known learning algorithm, for example, an error backpropagation method, and updates the weights (parameters) of the respective filters 94 and 96 described above in the neural network 90 to appropriate values, such as to minimize a loss function that represents a difference between the learning data SD and the reconfiguration image data. For example, BCE (Binary Cross-entropy) may be used as the loss function.

Repeating the processing of steps S103 to S105 multiple times minimizes the difference between the learning data SD and the reconfiguration image data in the neural network 90 and enables the more accurate reconfiguration image data to be output from the neural network 90.

In the case of input of image data with regard to the non-defective tablets 9 (the original image data XD according to one or more embodiments), the eventually obtained AI model 100 generates reconfiguration image data that is substantially identical with the input original image data XD. In the case of input of image data with regard to the defective tablet 9x (the original image data XD), on the other hand, the AI model 100 generates reconfiguration image data that is substantially identical with the original image data XD excluding a noise part (i.e., excluding a part corresponding to a defective portion). In other words, in the case of a tablet 9 that is defective, virtual image data with regard to the tablet 9 on the assumption that the tablet 9 has no defective part is generated as the reconfiguration image data with regard to the tablet 9.

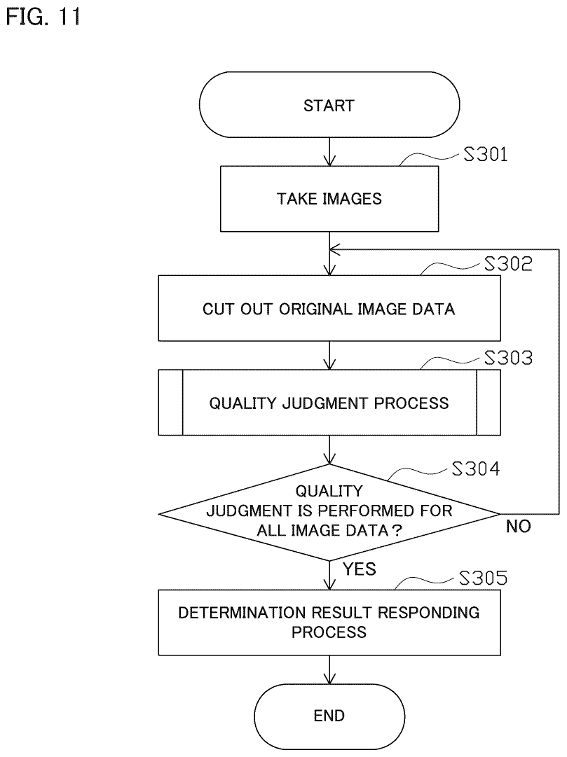

The following describes a process in relation to the quality judgment of the tablets 9 executed by the determination unit 8, with reference to the flowchart of FIG. 11. This process is performed at an ordinary execution timing of quality judgment that is set in advance or in response to a predetermination operation of the redetermination operating portion 85e.

At step S301, the determination unit 8 first uses the respective cameras 83 and 84 to take images of the tablets 9. More specifically, the camera controller 853 controls the respective cameras 83 and 84 to take images of the inspection target area KA in the respective conveying portions 41 and 43 by the respective cameras 83 and 84. Image data showing the entire inspection target area KA (the entire area data AD) is accordingly obtained.

At subsequent step S302, the data processor 856 performs a process of extracting (cutting out) an area corresponding to one line of multiple tablets 9 from the obtained entire area data AD, with regard to each line of the tablet 9. At step S302, original image data XD corresponding to one line is accordingly obtained from the entire area data AD.

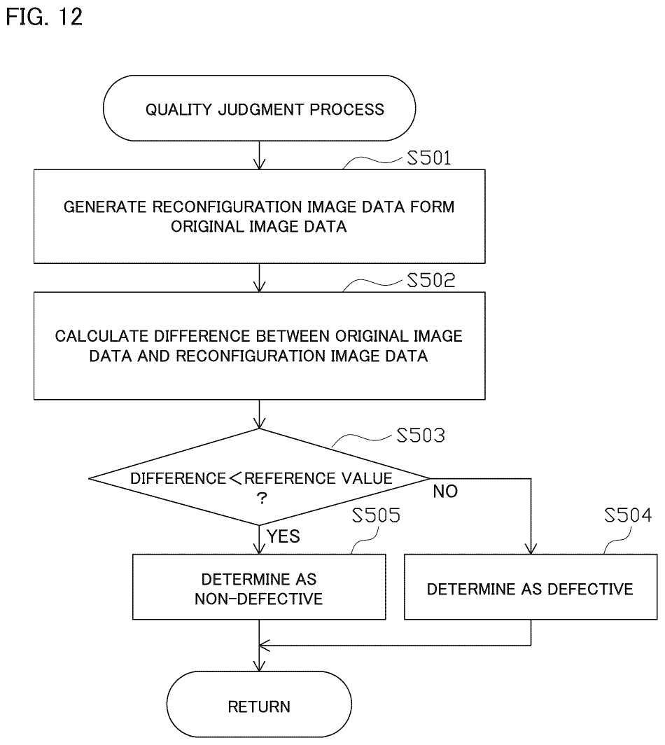

At step S303, the determination unit 8 executes a quality judgment process. More specifically, as shown in FIG. 12, at step S501, the inspection module 858 first causes the original image data XD obtained at step S302 to be input into the input layer of the AI model 100. As a result, reconfiguration image data is output from the AI model 100. According to one or more embodiments, the inspection module 858 configures the “reconfiguration image data obtaining unit”.

At subsequent step S502, the inspection module 858 compares the original image data XD with the reconfiguration image data and calculates a difference between both the image data. For example, the inspection module 858 compares dots at identical coordinates in both the image data with each other and calculates the area of a lump of dots (the number of dots) which have differences in luminance of not less than a predetermined value. According to one or more embodiments, the inspection module 858 that compares the original image data XD with the reconfiguration image data configures the “comparison unit”.

At step S503, the inspection module 858 subsequently determines whether there is any defective portion in the tablet 9. More specifically, the inspection module 858 determines whether each of the calculated differences is larger than a predetermined reference value. When the difference is larger than the predetermined reference value, it is determined that the tablet 9 is “defective” at step S504. When the difference is smaller than the predetermined reference value, on the other hand, it is determined that the tablet 9 is “non-defective” at step S505.

Referring back to FIG. 11, at step S304 subsequent to the quality judgment process of step S303, the determination unit 8 determines whether the quality judgment process of step S303 has been executed, based on all the original image data XD with regard to the image data obtained at step S301 (the entire area data AD). More specifically, a plurality of the original image data XD (an identical number of the original image data XD with the number of lines of the arrayed tablets 9) are obtained from the entire area data AD at step S301. The determination unit 8 then determines whether the quality judgment process of step S303 has been executed, based on all these original image data XD.

When the quality judgment process has been executed based on all the original image data XD (step S304: YES), the process proceeds to step S305. Otherwise (step S304: NO), the process goes back to step S302. Accordingly, the processing of step S302 and S303 is repeated until the quality judgment process has been executed based on all the original image data XD.

When the quality judgment has been executed based on all the original image data XD, the determination unit 8 performs a determination result responding process at step S305, which performs processing according to the result of the quality judgment. More specifically, in the case of determination as “non-defective” with regard to all the original image data XD as the result of the above quality judgment process based on all the original image data XD, the tablets 9 in the inspection target area KA as the imaging object are determined as “non-defective”. This result of determination is stored into the storage portion 85d. Furthermore, the display controller 854 causes information that indicates “non-defective” and the image data obtained at step S301 (the entire area data AD) to be displayed on the display portions 85b and 85c.

In the case of determination as “defective” with regard to at least one of the original image data XD, on the other hand, the tablet 9 in the inspection target area KA as the imaging object is determined as “defective”. This result of determination and information that indicates the position of a defective portion (for example, coordinate information) are stored into the storage portion 85d.

Furthermore, the display controller 854 causes information that indicates “defective” and information that correlates the information identifying the defective tablet 9x to the image data obtained at step S301 (the entire area data AD), to be displayed on the display portions 85b and 85c. According to one or more embodiments, a mark MK that indicates the position of the defective portion is displayed to be placed over the image data obtained at step S301 (the entire area data AD) (as shown in FIG. 13), based on the information that indicates the position of the defective portion described above. Accordingly, a specific mark MK that indicates the position of the defective tablet 9x and that also indicates the position of the defective portion in the defective tablet 9x is displayed to be placed over the image data (the entire area data AD).

In the case where a certain tablet 9 is determined as “defective” based on the image data obtained by first imaging of the certain tablet 9, the conveying of the tablets 9 is not temporarily stopped immediately after this determination. The conveying control device 7 temporarily stops the conveying of the tablets 9 at a timing when second imaging of the defective tablet 9x is to be performed.

Second imaging of the defective tablet 9x is performed in the state that the conveying is temporarily stopped. The quality judgment is then executed, based on image data obtained by this second imaging. This quality judgment generally determines the defective tablet 9x as “defective” in the same manner as the first quality judgment. The information (the mark MK) identifying the defective tablet 9x is displayed, in association with the image data (the entire area data AD) obtained by second imaging, on the display portions 85b and 85c. The image data (the entire area data AD) displayed on the display portions 85b and 85c is data obtained during a temporary stop of the tablets 9. Accordingly, the present conditions of the tablets 9 (for example, the positions, the intervals, and the orientations) are substantially consistent with the conditions of the tablets 9 shown by the image data displayed on the display portions 85b and 85c.

When such information is displayed, the examiner who performs the visual inspection identifies the defective tablet 9x based on this information and removes this defective tablet 9x from the conveying device 4 by using tweezers or the like. At this time, the present conditions of the tablets 9 are substantially consistent with the conditions of the tablets 9 shown by the image data displayed on the display portions 85b and 85c, so that the examiner can extremely readily identify the defective tablet 9 by utilizing the contents of the display on the display portions 85b and 85c.

After removing the defective tablet 9x, the examiner resumes the conveying of the tablets 9. The conveying of the tablets 9 cannot, however, be resumed by simply operating the conveyance operation device as described above. In order to resume the conveying of the tablets 9, the examiner is required to operate the redetermination operating portion 85e and execute the above quality judgment process again and to subsequently operate the conveyance operation device under condition that the tablets 9 are determined as “non-defective” by this quality judgment process executed again. The results of the determination and the image data with regard to the quality judgment process executed again are also displayed on the display portions 85b and 85c.

As described above in detail, according to one or more embodiments, the inspection module 858 executes the quality judgment of the tablets 9 that are conveyed by the conveying device 4 (i.e., the tablets 9 as the object of visual inspection). In the case of determination as defective by the inspection module 858, the conveying of the tablets 9 is temporarily stopped. Furthermore, information identifying the defective tablet 9x is displayed on the respective display portions 85b and 85c.

This configuration accordingly enables the examiner who performs a visual inspection to readily identify the defective tablet 9x among the plurality of tablets 9 by effectively using the contents of display on the display portions 85b and 85c. The tablets 9 are temporarily stopped in the case of determination as defective, so that the examiner can more precisely remove the identified defective tablet 9x. This configuration thus more certainly prevents the examiner from overlooking the defective tablet 9x, from missing out the defective tablet 9x, and from mistakenly removing a non-defective tablet 9 that is different from the defective tablet 9x. As a result, this more certainly prevents the defective tablet 9x from flowing to the downstream and further enhances the reliability of the visual inspection.

Furthermore, the information identifying the defective tablet 9x (the mark MK according to one or more embodiments) is displayed, in association with the image data with regard to the defective tablet 9x, on the display portions 85b and 85c. This accordingly further facilitates the identification of the defective tablet 9x and thereby further reduces the labor and the time required for removal of the defective tablet 9x.

Additionally, in the case where the defective tablet 9x is found and the conveying of the tablets 9 is temporarily stopped, the configuration of one or more embodiments allows the conveying device 4 to be restarted and resume the conveying of the tablets 9, only when the result of determination as “non-defective” is given based on the redetermination image data obtained by imaging of a range corresponding to at least the defective tablet 9x (i.e., a range including a position where the defective tablet 9x is located). This configuration furthermore certainly prevents the defective tablet 9x from mistakenly flowing to the downstream, even when the examiner forgets to remove the defective tablet 9x or mistakenly removes another tablet 9. As a result, this furthermore enhances the reliability of the visual inspection.

Moreover, the image data obtained by extracting the area corresponding to one line of multiple tablets 9 that are adjacent to one another in a conveying direction, per each line of the tablets 9 is used as the learning data SD and as the original image data XD. This configuration relatively reduces the amount of data required for learning and is thereby expected to reduce the cost required for learning. This configuration also further facilitates the process of extracting the learning data SD and the original image data XD.

Furthermore, the configuration of one or more embodiments compares the original image data XD with the reconfiguration image data, which is reconfigured by inputting the original image data XD into the AI model 100, and executes the quality judgment of each tablet 9, based on the result of the comparison. Both the image data to be compared with each other respectively relate to one identical tablet 9. Accordingly, the respective image data to be compared with each other have substantially the same shapes and the appearances of the tablet 9. This configuration does not need to set relatively mild judgment conditions with a view to preventing false detection due to a difference in the shape or in the appearance but allows the stricter judgment conditions to be set. Moreover, this configuration enables the imaging conditions (for example, the locations and the angles of placement of the tablets 9, the light and dark conditions, and the angles of view of the cameras) to be consistent with each other in both the image data that are to be compared with each other. As a result, this enables the quality judgment of the tablets 9 to be executed with extremely high accuracy.

Additionally, according to one or more embodiments, there is provided the reversing portion 42 configured to reverse the front side and the rear side of the tablets 9. This configuration facilitates the visual inspection of the front face 9a and the rear face 9b of the tablet 9.

The present disclosure is not limited to the description of the above embodiments but may be implemented, for example, by configurations described below. The present disclosure may also be naturally implemented by applications and modifications other than those illustrated below.

(a) In the embodiments described above, the respective cameras 83 and 84 are placed above the conveying path of the tablets 9 and are respectively configured to take images of the upper faces of the tablets 9.

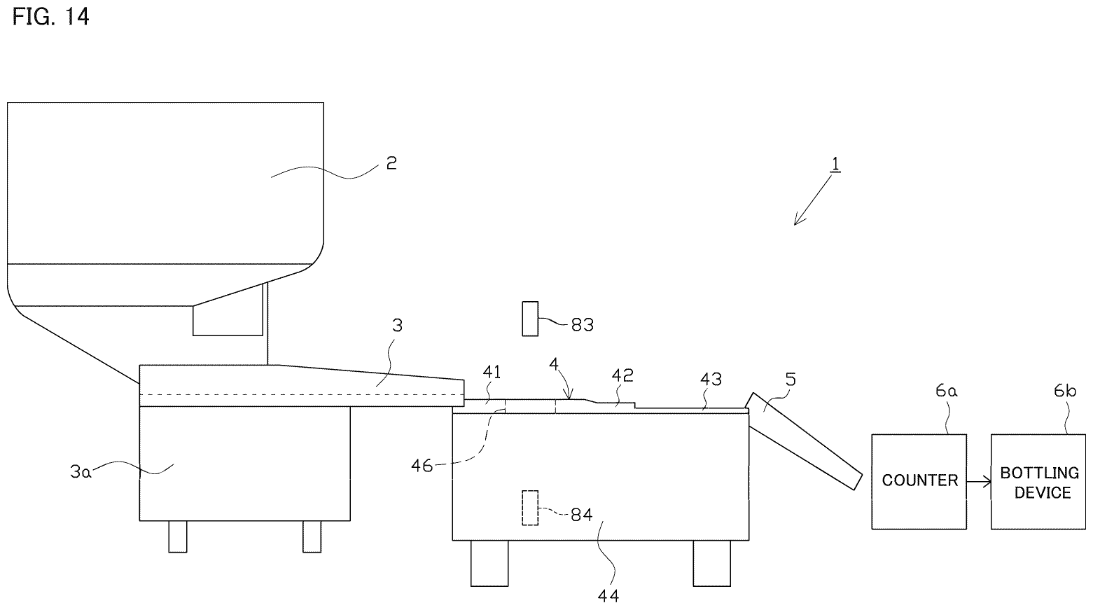

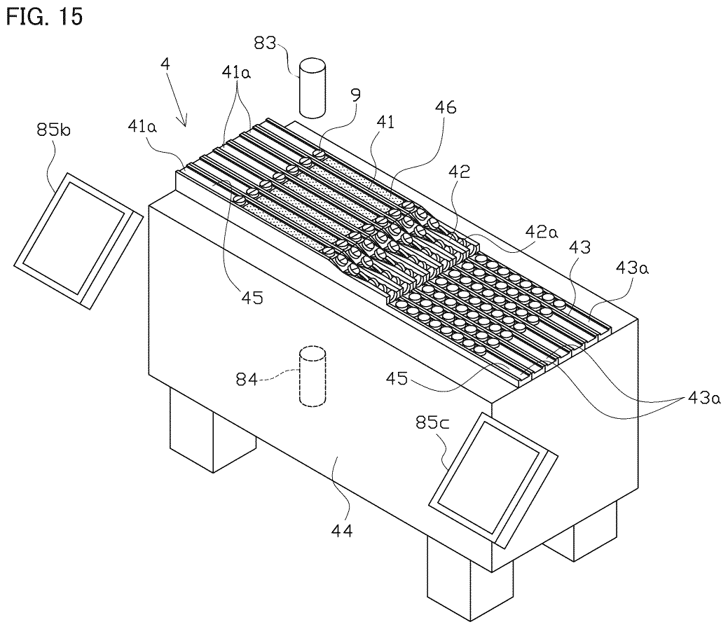

According to a modification, however, as shown in FIG. 14 and FIG. 15, a transparent or translucent transmission part 46 (a part filled with a dotted pattern in FIG. 15) may be provided in at least part of the tablet support base 45, and the cameras 83 and 84 may be placed at such positions that the tablet support base 45 is placed vertically between the two cameras 83 and 84. The first camera 83 may be configured to take images of the upper faces of the tablets 9, and the second camera 84 may be configured to take images of the lower faces of the tablets 9 through the transmission part 46. More specifically, the first camera 83 may be configured to take an image of one of the front face 9a and the rear face 9b of each tablet 9, and the second camera 84 may be configured to take an image of another of the front face 9a and the rear face 9b of the tablet 9 through the transmission part 46. The inspection module 858 may be configured to execute the quality judgment of each tablet 9, based on respective image data with regard to the front face 9a and the rear face 9b of the tablet 9 obtained by the respective cameras 83 and 84.

In the configuration of the modification described above, the second camera 84 is placed below the tablet support base 45. This configuration prevents the second camera 84 from interfering with the visual inspection.

Furthermore, the configuration of this modification allows the conveying device 4 to be activated (restarted) only when both the front face 9a and the rear face 9b of each tablet 9 are determined as non-defective by the quality judgment based on the redetermination image data. This configuration accordingly does not allow the conveying device 4 to be activated (restarted) in the case where the examiner misses out the defective tablet 9x and this defective tablet 9x is turned upside down. Accordingly, this configuration of the modification significantly effectively prevents the defective tablet 9x from flowing to the downstream.

(b) According to the embodiments described above, the image data obtained by extracting the area corresponding to one line of multiple tablets 9 from the image data (the entire area data AD) that indicates the entire inspection target area KA, per each line of the tablets 9 is used as the original image data XD and as the learning data SD. According to a modification, however, for example, the entire area data AD or image data obtained by extracting each area of an individual tablet 9 from the entire area data AD may be used as the original image data XD and as the learning data SD.

I According to the embodiments described above, the inspection module 858 is configured to execute the quality judgment for the front face 9a and the rear face 9b of each tablet 9. According to a modification, however, the inspection module 858 may be configured to additionally execute the quality judgment for the side face 9c of the tablet 9.

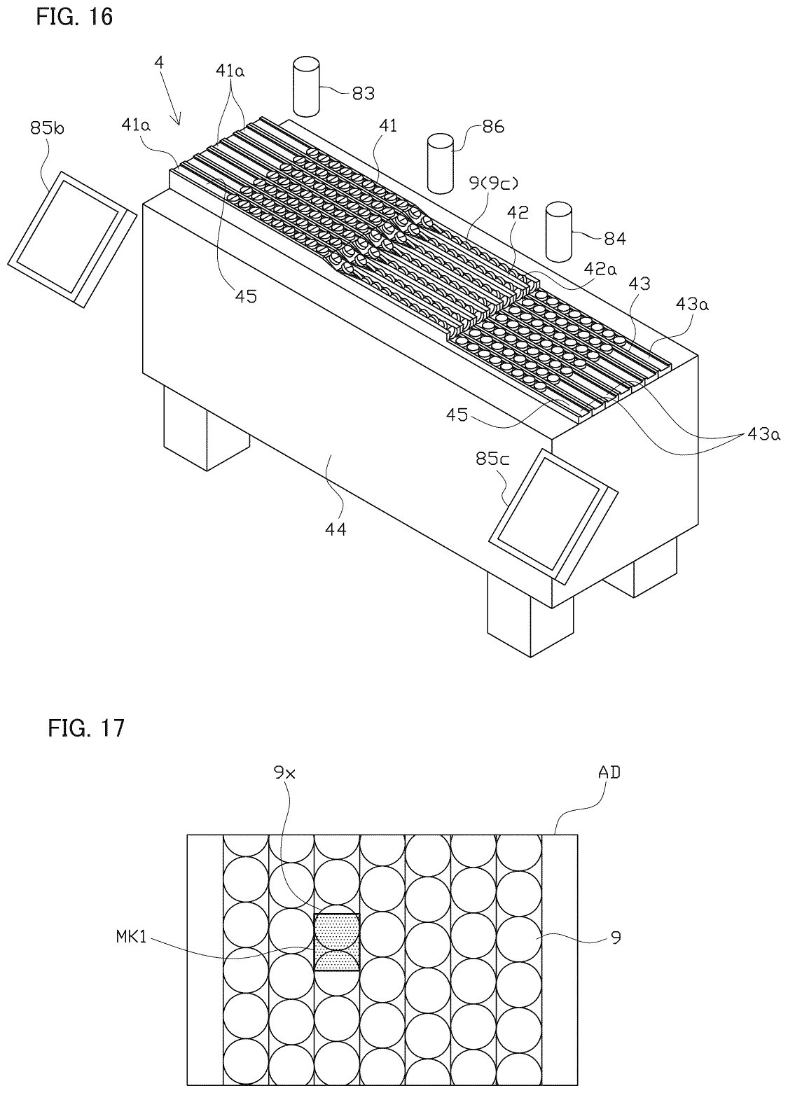

For example, in the process of reversing the front side and the rear side of the tablets 9 by the reversing portion 42, the side faces 9c of the tablets 9 face up. The modification may take advantage of this fact and may be provided with a side face camera 86 configured to take images of the side faces 9c of the tablets 9 located in the reversing portion 42, as shown in FIG. 16. The inspection module 858 may be configured to execute the quality judgment with regard to the side faces 9c, based on image data obtained by this side face camera 86. The side face camera 86 configures the “side face imaging device” and the “imaging device”.

The configuration of this modification enables the quality judgment with regard to the side faces 9c of the tablets 9 to be executed by taking advantage of the reversing portion 42. Accordingly, this configuration furthermore enhances the accuracy in the quality judgment of the tablets 9. This configuration furthermore certainly prevents the defective tablet 9x from flowing to the downstream and thereby further enhances the reliability of the visual inspection.

(d) Covers may be provided to cover the entirety or part of the upstream-side conveying portion 41, the reversing portion 42 and the downstream-side conveying portion 43. A modified configuration may use cameras (imaging devices) placed inside of the cover and may execute the quality judgment of the tablets 9, based on image data obtained by the cameras.

Furthermore, the conditions of the cover may be used as conditions of execution of imaging by the cameras 83 and 84 to obtain the redetermination image data. For example, such conditions that the cover is appropriately placed and that an opening provided in the cover is closed may be set as conditions for resuming the conveying or for executing imaging.

(e) The above embodiments are configured to take images of one tablet 9 at least twice by each of the cameras 83 and 84. The number of times of imaging with regard to one tablet 9 may, however, be changed appropriately.

(f) In the case where determination of a tablet 9 as defective is given based on the image data obtained by first imaging, the configuration of the above embodiments temporarily stops the conveying of the tablets 9 at the timing when second imaging of the tablet 9 is performed. The timing of the temporary stop may, however, be changed appropriately. For example, a modified configuration may temporarily stop the conveying of the tablets 9 immediately after the determination as defective.

In this modified configuration, some time period is required from execution of imaging to completion of the quality judgment. At the time when the conveying of the tablets 9 is stopped, the actual position of the defective tablet 9x is thus likely to be slightly different from the position of the defective tablet 9x in the image data (the entire area data AD) used for the quality judgment.

For example, a modification may thus be configured to obtain and estimate in advance an average conveyance amount of the tablets 9 for a time period from execution of imaging to completion of the quality judgment and to display a mark MK1 that indicates a position downstream of the defective tablet 9x by the average conveyance amount, in association with the image data (the entire area data AD) with regard to the defective tablet 9x, on the display portions 85b and 85c as shown in FIG. 17. This modified configuration also enables the defective tablet 9x to be identified relatively easily. A mark that indicates a relatively wide range along the conveying direction of the tablet 9 may be used as the mark MK1, by taking into account a possible difference between the actual conveyance amount and the average conveyance amount.

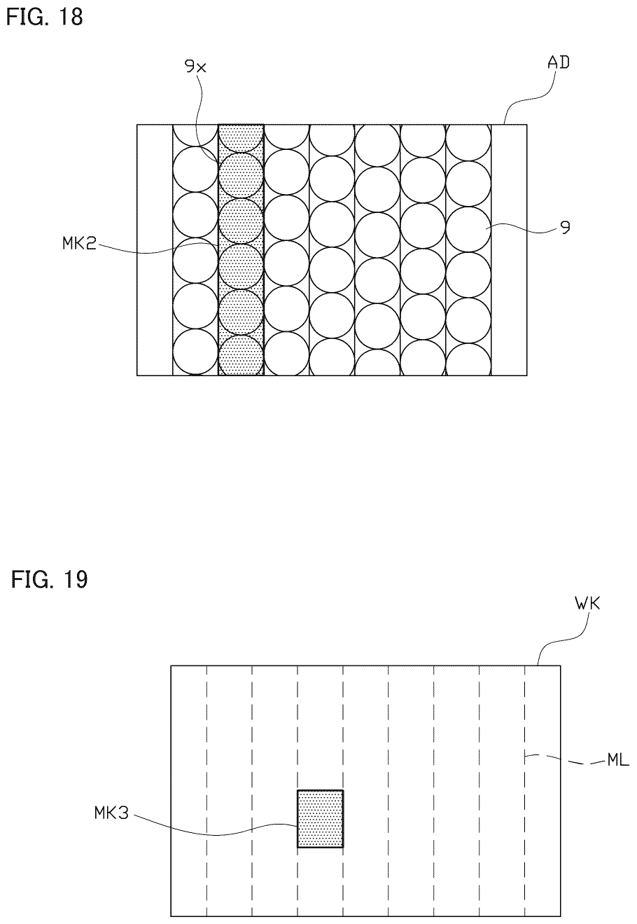

In another example, as shown in FIG. 18, a mark MK2 that indicates a line of arrayed tablets including the defective tablet 9x may be displayed in association with the image data (the entire area data AD) with regard to the defective tablet 9x. This modified configuration also enables the defective tablet 9x to be identified relatively easily.

It is not necessarily required to display the information identifying the defective tablet 9x in association with the image data with regard to the defective tablet 9x. For example, as shown in FIG. 19, a modified configuration may display a mark MK3 th33ndicatestes the position of the defective tablet 9x in a frame WK corresponding to the inspection target area KA (the range of imaging by the cameras 83, 84 and 86). In this modification, a frame border that indicates the inspection target area KA (the range of imaging by the cameras 83, 84 and 86) may be provided on an upper face of the conveying device 4 (for example, the upstream-side conveying portion 41 and the downstream-side conveying portion 43). This modified configuration further facilitates the identification of the defective tablet 9x based on the contents of the display. For example, auxiliary lines ML corresponding to the conveying grooves 41a, 42a and 43a may additionally be provided in the frame WK.

(g) According to the embodiments described above, a disk-shaped flat tablet having a circular shape in planar view is illustrated as the tablet 9. The type, the shape and the other configuration of the tablet are, however, not limited to those of the above embodiments. For example, the tablet includes not only medicinal tablets but tablets used for eating and drinking. The tablet also includes not only uncoated tablets but sugar-coated tablets, film-coated tablets, orally disintegrating tablets, enteric coated tablets, and gelatine encapsulated tablets, as well as a variety of capsule tablets including hard capsules and soft capsules.

The shape of the tablet 9 is not necessarily limited to the circular shape in planar view but may be, for example, a polygonal shape in planar view, an elliptical shape in planar view or an oval shape in planar view.

(h) The above embodiments are configured to supply the tablets 9 from the visual inspection assistance device 1 (the chute 5) to the counter 6a and the bottling device 6b. The supply object of the tablets 9 may, however, be changed appropriately. For example, the tablet 9 may be placed in a pocket portion formed in a container film, and the supply object of the tablets 9 may be a blister packaging machine (for example, a PTP packaging machine) configured to manufacture a blister sheet (for example, a PTP sheet) by mounting a cover film to the container film such as to close the pocket portion. The blister packaging machine may be provided with the visual inspection assistance device 1.

(i) The configuration of the AI model 100 (the neural network 90) serving as the “identification unit” and the learning method thereof are not limited to those of the embodiments described above. For example, a modified configuration may process a variety of data by a normalization process or the like as needed basis in the course of a learning process of the neural network 90 or in the course of a process of obtaining the reconfiguration image data. Moreover, the structure of the neural network 90 is not limited to the structure shown in FIG. 9 but may be provided with a pooling layer subsequent to the convolution layer 93. A modified configuration may employ, for example, a different number of layers of the neural network 90, a different number of nodes in each layer, and a different connecting structure of the respective nodes.

Furthermore, according to the embodiments described above, the AI model 100 (the neural network 90) is the generation model having the configuration of the convolutional autoencoder (CAE). This configuration is, however, not restrictive. The AI model 100 (the neural network 90) may be a generation model having the configuration of a different type of autoencoder, for example, a variational autoencoder (VAE).

The above embodiments are configured to perform learning of the neural network 90 by the error backpropagation method. This configuration is, however, not restrictive. Learning of the neural network 90 may be performed by using any of various other learning algorithms.

Moreover, the neural network 90 may be configured by a dedicated AI processing circuit, such as an AI chip. In this case, only learning information such as parameters may be stored in the storage portion 85d. In this modification, the AI model 100 may be configured by setting the learning information, which is read out by the dedicated AI processing circuit, in the neural network 90.

Additionally, according to the embodiments described above, the control system 85 includes the learning module 857 and is configured to perform learning of the neural network 90 inside of the control system 85. This configuration is, however, not restrictive. For example, a modified configuration with omission of the learning module 857 may cause learning of the neural network 90 to be performed outside of the control system 85 and may store the AI model 100 learnt outside (the learnt neural network 90) into the storage portion 85d. The learning data SD may also be generated outside of the control system 85.

j) The configuration of the conveying device 4 is not limited to the configuration described in the above embodiments. For example, the conveying device may be configured as a conveyor and the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . visual inspection assistance device, 4 . . . conveying device, 7 . . . conveying control device, 9 . . . tablet

9a . . . front face, 9b . . . rear face, 9c . . . side face, 42 . . . reversing portion, 45 . . . tablet support base, 46 . . . transmission part, 83 . . . first camera (imaging device, first imaging device), 84 . . . second camera (imaging device, second imaging device), 85b . . . first display portion (first display), 85c . . . second display portion (second display), 86 . . . side face camera (imaging device, side face imaging device), 90 . . . neural network, 91 . . . encoder portion (encoding unit), 92 . . . decoder portion (decoding unit), 100 . . . AI model (identification unit), 853 . . . camera controller (imaging control unit), 854 . . . display controller (display control unit), 858 . . . inspection module (determination unit, reconfiguration image data obtaining unit, comparison unit)

What is claimed is:

1. A visual inspection assistance device, comprising:
a conveying device that conveys tablets as an object of a visual inspection;
an imaging device that takes an image of the tablets that are conveyed by the conveying device;
a display device;
a central processing unit (CPU) that:
determines, based on image data obtained by the imaging device, whether one or more of the tablets are defective, and
displays, in the display device, information identifying the one or more of the tablets that have been determined to be defective; and
a conveying control device that temporarily stops the conveying device from conveying the tablets in response to the CPU determining that the one or more of the tablets are detective.

2. A visual inspection assistance device,:
a conveying device that conveys tablets as an object of a visual inspection;
an imaging device that takes an image of the tablets that are conveyed by the conveying device;
a display device;
a central processing unit (CPU) that:
determines, based on image data obtained by the imaging device, whether one or more of the tablets are defective, and
displays, in the display device, information identifying the one or more of the tablets that have been determined to be defective; and
a conveying control device that temporarily stops the conveying device from conveying the tablets in response to the CPU determining that the one or more of the tablets are detective, wherein
the CPU further:
controls the imaging device to image a range corresponding to the tablets that have been determined to be defective and to obtain redetermination image data during a temporary stop of the tablets, and
determines, based on the redetermination image data, whether one or more of the tablets are defective,
the conveying control device restarts the conveying device to resume the conveying of the tablets that has been temporarily stopped, under condition that the tablets are non-defective as a result of the determining based on the redetermination image data.

3. A visual inspection assistance device, comprising:
a conveying device that conveys tablets as an object of a visual inspection;
an imaging device that takes an image of the tablets that are conveyed by the conveying device;
a display device;
a central processing unit (CPU) that:
determines, based on image data obtained by the imaging device, whether one or more of the tablets are defective, and
displays, in the display device, information identifying the one or more of the tablets that have been determined to be defective; and
a conveying control device that temporarily stops the conveying device from conveying the tablets in response to the CPU determining that the one or more of the tablets are detective, wherein
the conveying device conveys the tablets arrayed in a plurality of lines, the CPU further:
obtains reconfiguration image data that is reconfigured by inputting original image data that is based on the image data obtained by the imaging device into a model, wherein
the model is generated by learning of a neural network using only learning data based on image data with regard to non-defective tablets, and
the neural network comprises an encoder portion configured to extract a feature quantity from input image data, and a decoder portion configured to reconfigure image data from the feature quantity, and
compares the original image data with the reconfiguration image data, and
determines, based on a result of the comparing, whether one or more of the tablets are defective,
the learning data comprises image data obtained by extracting, per each line of the tablets, an area corresponding to one line of multiple tablets from the image data with regard to the non-defective tablets, and
the original image data comprises image data obtained by extracting, per each line of the tablets, an area corresponding to one line of multiple tablets from the image data obtained by the imaging device.

4. The visual inspection assistance device according to claim 1, wherein
the CPU displays, in the display device, the information identifying the one or more tablets that have been determined to be defective, in association with the image data with regard to the tablet.

5. The visual inspection assistance device according to claim 2, wherein
the CPU displays, in the display device, the information identifying the one or more of the tablets that have been determined to be defective, in association with the image data with regard to the tablet.

6. The visual inspection assistance device according to claim 3, wherein
the CPU displays, in the display device, the information identifying the one or more of the tablets that have been determined to be defective, in association with the image data with regard to the tablet.

7. The visual inspection assistance device according to claim 1, wherein
each of the tablets has a front face and a rear face,
the conveying device comprises a tablet support base configured to support the tablets that are conveyed, wherein at least part of the tablet support base has a transmission part that is transparent or translucent,
the imaging device comprises a first imaging device and a second imaging device placed at such positions that the tablet support base is placed between the first imaging device and the second imaging device,
the first imaging device takes images of one of the front faces and the rear faces of the tablets, and the second imaging device takes images of another of the front faces and the rear faces of the tablets through the transmission part, and
the CPU determines whether one or more of the tablets are defective based on image data with regard to the front faces and the rear faces of the tablets obtained by the first imaging device and the second imaging device.

8. The visual inspection assistance device according to claim 2, wherein
each of the tablets has a front face and a rear face,
the conveying device comprises a tablet support base configured to support the tablets that are conveyed, wherein at least part of the tablet support base has a transmission part that is transparent or translucent,
the imaging device comprises a first imaging device and a second imaging device placed at such positions that the tablet support base is placed between the first imaging device and the second imaging device,
the first imaging device takes images of one of the front faces and the rear faces of the tablets, and the second imaging device takes images of another of the front faces and the rear faces of the tablets through the transmission part, and
the CPU determines whether one or more of the tablets are defective based on image data with regard to the front faces and the rear faces of the tablets obtained by the first imaging device and the second imaging device.

9. The visual inspection assistance device according to claim 3, wherein
each of the tablets has a front face and a rear face,
the conveying device comprises a tablet support base configured to support the tablets that are conveyed, wherein at least part of the tablet support base has a transmission part that is transparent or translucent,
the imaging device comprises a first imaging device and a second imaging device placed at such positions that the tablet support base is placed between the first imaging device and the second imaging device,
the first imaging device takes images of one of the front faces and the rear faces of the tablets, and the second imaging device takes images of another of the front faces and the rear faces of the tablets through the transmission part, and
the CPU determines whether one or more of the tablets are defective based on image data with regard to the front faces and the rear faces of the tablets obtained by the first imaging device and the second imaging device.

10. The visual inspection assistance device according to claim 1, wherein
each of the tablets has a front face, a rear face, and a side face located between the front face and the rear face,
the conveying device includes a reversing portion configured to reverse a front side and a rear side of the tablets that are conveyed,
the imaging device comprises a side face imaging device that takes images of the side faces of the tablets located in the reversing portion, and
the CPU determines whether one or more of the tablets are defective with regard to the side faces of the tablets based on image data obtained by the side face imaging device.

11. The visual inspection assistance device according to claim 2, wherein
each of the tablets has a front face, a rear face, and a side face located between the front face and the rear face,
the conveying device includes a reversing portion configured to reverse a front side and a rear side of the tablets that are conveyed,
the imaging device comprises a side face imaging device that takes images of the side faces of the tablets located in the reversing portion, and
the CPU determines whether one or more of the tablets are defective with regard to the side faces of the tablets based on image data obtained by the side face imaging device.

12. The visual inspection assistance device according to claim 3, wherein
each of the tablets has a front face, a rear face, and a side face located between the front face and the rear face,
the conveying device includes a reversing portion configured to reverse a front side and a rear side of the tablets that are conveyed,
the imaging device comprises a side face imaging device that takes images of the side faces of the tablets located in the reversing portion, and
the CPU determines whether one or more of the tablets are defective with regard to the side faces of the tablets based on image data obtained by the side face imaging device.
